(19) United States
(12) Patent Application Publication
(10) Pub. No.: US 2026/0109400 A1
(43) Pub. Date: Apr. 23, 2026

(54) SELF-PROPELLED AND REVERSE SELF-STEERING QUAD CAMPER TRAILER

(71) Applicant: Michal Pospieszalski, Star Valley Ranch, WY (US)

(72) Inventor: Michal Pospieszalski, Star Valley Ranch, WY (US)

(21) Appl. No.: 19/221,478

(22) Filed: May 28, 2025

Related U.S. Application Data
(60) Provisional application No. 63/571,167, filed on Mar. 28, 2024.
(60) Provisional application No. 63/655,940, filed on Jun. 4, 2024.

(51) Int. Cl. B62D 6/00; B60D 1/14; B60G 17/017; B60L 7/10; B60P 3/32; B62D 13/00; B62D 59/04

(52) U.S. Cl. CPC B62D 6/002; B60D 1/143; B60G 17/017; B60L 7/10; B62D 13/00; B60G 2300/04; B60G 2500/30; B60L 2200/28; B60P 3/32; B62D 59/04

(57) ABSTRACT

A trailer may comprise a front set of wheels and a rear set of wheels, where at least one set of wheels may be electronically steerable, and an electronic control unit that may be configured to receive steering input and control the at least one set of steerable wheels to simulate single-axle trailer behavior. The steering input may comprise angle sensor data or may be received via an OBD port connection. The electronic control unit may operate in multiple operational modes including forward mode, reverse mode, and remote control mode for unhitched operation. The trailer may further comprise regenerative braking, a hinged tow bar that may be rotatable to a vertical storage position, and an adjustable suspension system that may provide a raised travel mode for off-road ground clearance and a lowered camping mode. The suspension system may level the trailer and accommodate slide-out sections in the lowered camping mode.

### CROSS-REFERENCE TO RELATED APPLICATIONS

This application claims the benefit of U.S. Provisional Ser. No. 63/571,167, filed Mar. 28, 2024, entitled “SELF-PROPELLED AND REVERSE SELF-STEERING QUAD CAMPER,” the technical disclosure of which is incorporated herein by reference for all purposes consistent with the present application.

This application also claims the benefit of U.S. Provisional Ser. No. 63/655,940, filed Jun. 4, 2024, entitled “SELF-PROPELLED TRUCK CAMPER,” the technical disclosure of which is incorporated herein by reference for all purposes consistent with the present application.

### BACKGROUND

### Field

The present invention relates generally to recreational campers, and more particularly, to an improved wheel system and trailer configuration to provide improved driving/handling features and improved camper configuration.

### BACKGROUND

Conventional camping travel trailers are designed to be towed behind a vehicle, a tow vehicle, and typically have a mid-wheel configuration with either a single or dual axle. In this configuration the trailer wheels are in the middle of the trailer and some significant weight of the trailer is supported by the tow vehicle via the tongue of the trailer resting on the tow vehicle hitch. This results in a simple trailer and tow vehicle configuration that is easy to turn and can be backed up with a little practice. However, this conventional layout has a number of limitations.

The tongue weight transfer significantly limits tow vehicle compatibility by increasing payload in the tow vehicle. For example, most tow vehicle trailer combinations cannot accommodate a camper in the truck bed and a towed camper simultaneously due to exceeding the tow vehicle payload limit.

The interior ‘livable’ layout of the trailer is limited by the presence of wheels in the middle that reduce the amount of vertical height available, thus cramping the interior. The trailer is unstable on its own and requires leveling tools upon parking and additional deployment, for example slide-outs or stabilizing jacks. The trailer is difficult move on its own for example being difficult to couple and uncouple to the tow vehicle due to the significant tongue weight.

The trailer's conventional tongue is typically integral to the trailer's frame. This configuration is dictated by the need to transfer and support the trailer's weight to the towing vehicle. Specifically, the tongue extends forward from the trailer's main body as a protruding rigid structure, facilitating the distribution of weight to the towing vehicle.

The tongue structure adds to the overall length of the trailer but does not provide any usable/livable area of the trailer. Often the trailer length for a user is limited to fit in a garage. So, for example a trailer for a 16′ deep garage needs 5′ for the tongue structure, thus limiting the overall usable interior space to 11′.

### BRIEF SUMMARY OF THE INVENTION

This invention relates to a trailer comprising a front set of wheels and a rear set of wheels, where at least one set of wheels is electronically steerable. The trailer includes an electronic control unit configured to receive steering input and control the steerable wheels to simulate single-axle trailer behavior. The steering input may comprise angle sensor data measuring the angle between the trailer and towing vehicle, or may be received via an OBD port connection.

The electronic control unit operates in multiple operational modes including forward mode, reverse mode, and remote control mode for unhitched operation. In reverse mode, the system actively steers wheels to simulate single-axle trailer behavior during backing up. The electronic control unit can automatically detect the operational mode based on reverse light signals or wheel rotation direction.

The trailer may further include regenerative braking where wheel motors act as generators during braking to charge trailer batteries. A hinged tow bar is provided where the tongue weight consists essentially of the tow bar weight, and the tow bar is rotatable to a vertical storage position.

An adjustable suspension system provides a raised travel mode for off-road ground clearance and a lowered camping mode with ground-to-floor step height of less than 10 inches. The suspension system can level the trailer when in the lowered camping mode. At least one slide-out section may extend in the lowered camping mode with a slide-out floor height within 3 inches of the main trailer floor height. The trailer accommodates wheel sizes up to 35 inches in diameter.

### BRIEF DESCRIPTION OF THE DRAWINGS

FIG. 1A is a perspective rear right-side view of a quad camper trailer.

FIG. 1B is a perspective front right-side view of the quad camper trailer.

FIG. 1C is a perspective front left-side view of the quad camper trailer.

FIG. 1D is a perspective rear left-side view of the quad camper trailer.

FIG. 2 illustrates a block diagram for the control system for the Quad Camper.

FIG. 3 is an overhead view of the quad camper trailer being towed by a towing vehicle with labels of relevant angles for controlling the quad wheels to simulate a single axle trailer.

FIG. 4A is a rear left perspective view of the quad camper trailer in a fully deployed configuration.

FIG. 4B is a rear right perspective view of the quad camper trailer in a fully deployed configuration.

FIG. 4C is a front right perspective view of the quad camper trailer in a fully deployed configuration.

FIG. 4D is a rear left perspective view of the quad camper trailer in a fully deployed configuration, showing a vertical cutaway.

FIG. 4E is a rear right perspective view of the quad camper trailer in a fully deployed configuration, showing a horizontal cutaway through the pop-up second story.

FIG. 4F is a front right perspective view of the quad camper trailer in a fully deployed configuration, showing a horizontal cutaway through the roof.

FIG. 4G is a top rear right perspective view of the quad camper trailer in a fully deployed configuration, showing a horizontal cutaway below the roof.

FIG. 4H is a top front right perspective view of the quad camper trailer in a fully deployed configuration, showing a horizontal cutaway below the roof.

### DETAILED DISCLOSURE

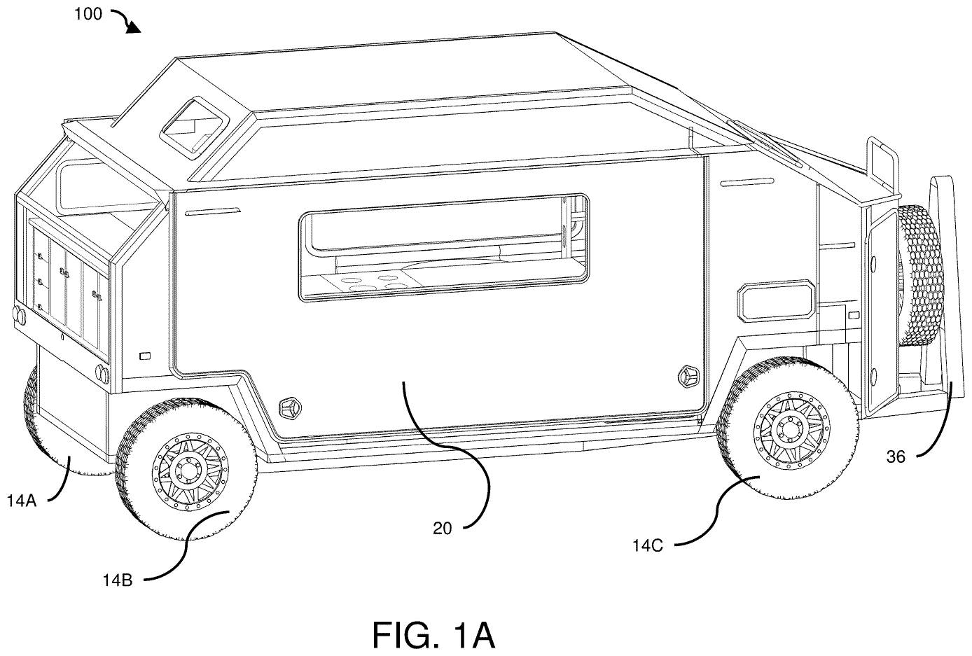

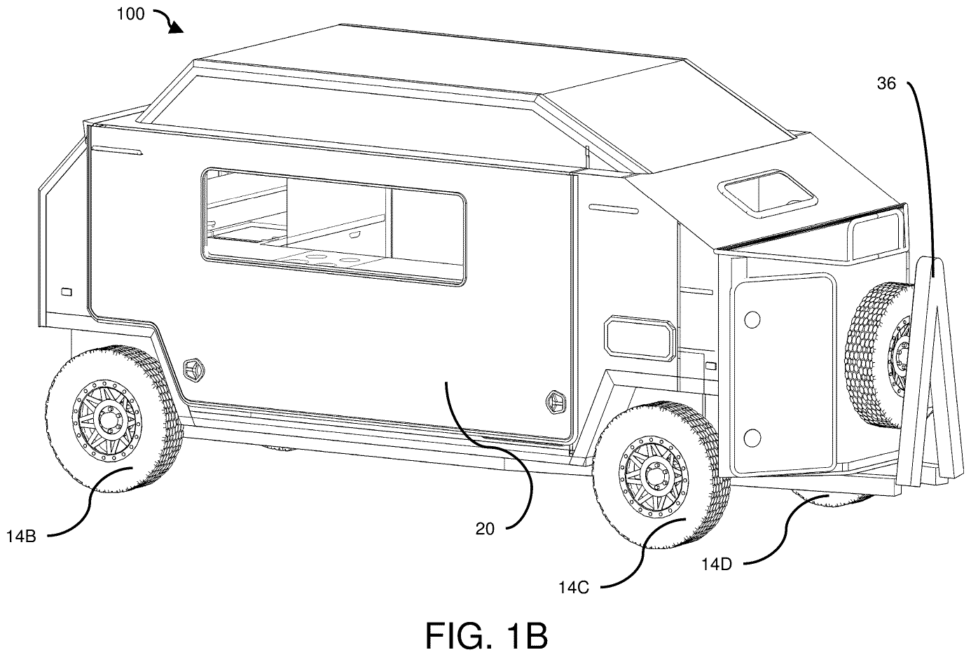

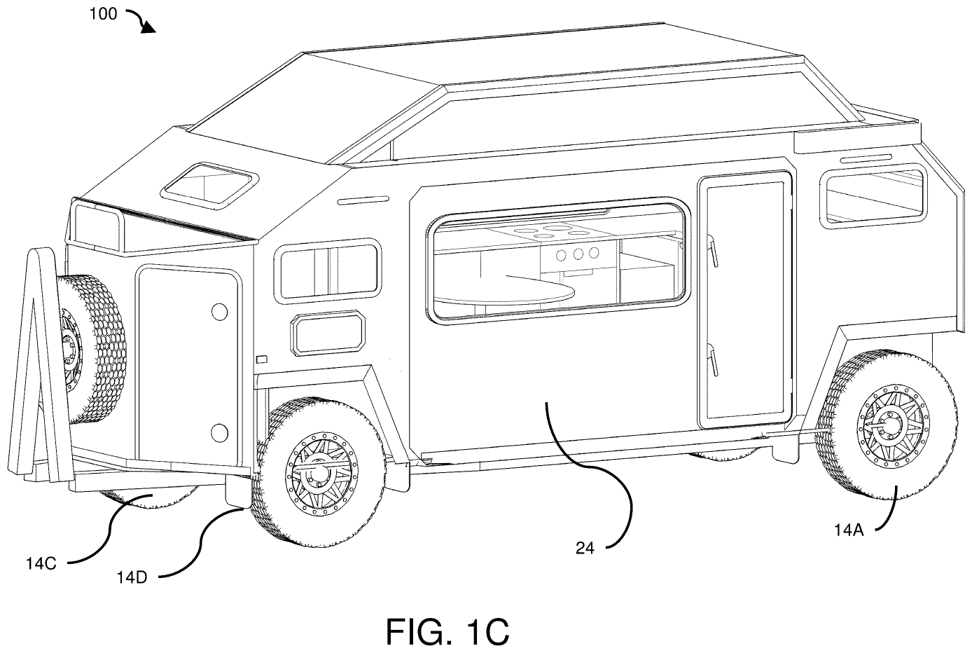

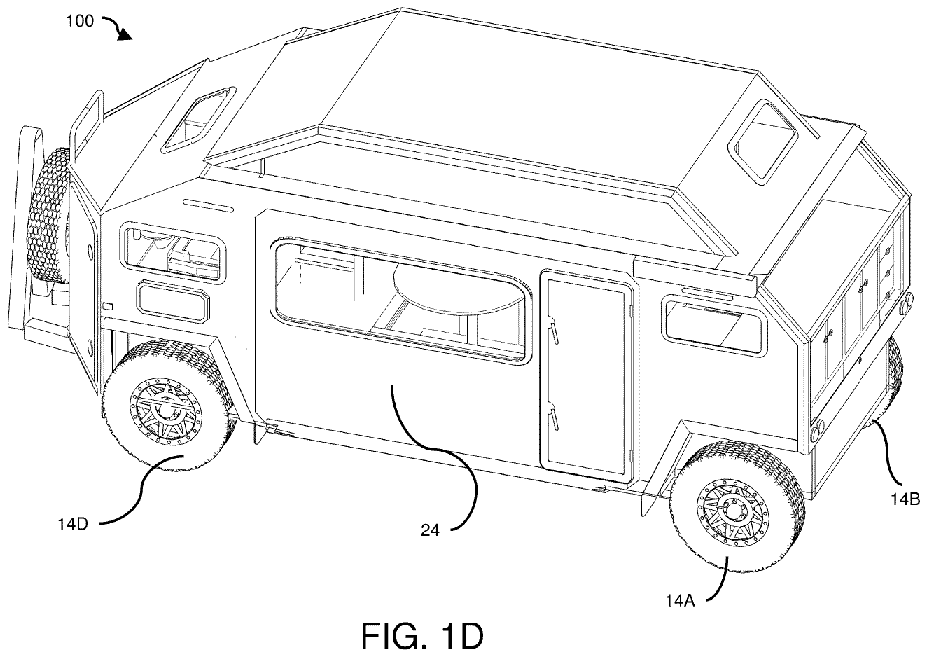

FIGS. 1A-1D show perspective views of a Quad Camper Trailer 100. The Quad Camper Trailer 100 is a 4-wheel camper with a wheel layout similar to a car.

The quad camper trailer 100 is shown having four wheels: a rear left wheel 14A, a rear right wheel 14B, a front right wheel 14C and a front left wheel 14D. The four wheels 14A, 14B, 14C and 14D may be capable of steering and may be capable of propelling the quad camper trailer 100 for low-speed operations. The front set of wheels 14C and 14D, the rear set of wheels 14A and 14B or both sets of wheels may be powered.

‘Wheels positioned at corners of the trailer’ refers to a wheel configuration where the wheels are located substantially near the four corners of the trailer frame, as distinguished from conventional mid-trailer axle placement. In this configuration, the wheels are positioned within the front and rear quarters of the trailer length, creating a wheel-free center section. For example, in a 16-foot trailer, the front wheels would be located within approximately the front 4 feet (or less) and the rear wheels within approximately the rear 4 feet (or less) of the trailer, leaving 8 feet or more of wheel-free space in the center section. Similar proportions on different size trailers. This corner positioning enables the trailer floor to be lowered without interference from wheels or axles in the middle portion of the trailer. The exact positioning may vary based on trailer size and design requirements, but the wheels remain substantially displaced from the center to create an unobstructed lower floor area.

The quad camper trailer 100 may have a hinged tow bar 36, for example a triangular shaped with a conventional ball socket receiver. Typical trailers are restricted to have their tongue weight be under the tow vehicle's maximum tongue weight. In a conventional trailer weighing 5000 lb the tongue weight is 500-700 lb. With the quad camper trailer 100, the tongue weight consists essentially of the tow bar weight itself, as the trailer's weight is fully supported by its four wheels, resulting in a tongue weight that will be less than a conventional trailer, being under 150 lbs., or better under 100 lbs. or better yet under 50 lbs. The tow bar can be rotated to a vertical position allowing the trailer to fit in shorter garages and take up less space than a conventional trailer. The hinged tow bar results in being able to make the usable area of the trailer far longer while still fitting in the garage.

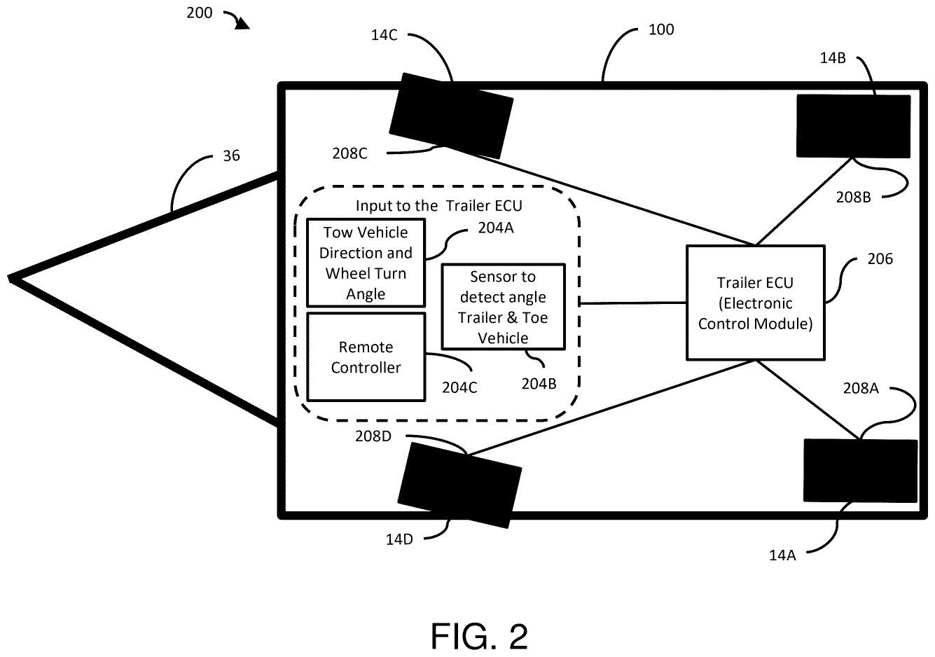

FIG. 2 illustrates a block diagram 200 for a trailer 100 that includes a trailer ECU 206 (Electronic Control Unit), which controls the wheels of the trailer, responding to input sources 204A, 204B, and 204C. There may be multiple input sources and the Trailer ECU 206 may only respond to one input source at any given time.

The ECU 206 may control the turning of the camper wheels, to steer the camper when reversing so it behaves in the same manner as a conventional middle wheel trailer.

When the trailer 100 is hitched to a towing vehicle, the tow vehicle input 204A may provide the input to the Trailer ECU 206. The tow vehicle input 204A may include a steering angle and speed of the towing vehicle. With this input the Trailer ECU 206 ensures that the trailer follows the tow vehicle accurately, simulating standard single-axle trailer behavior, allowing the four-wheel trailer to track and maneuver like a conventional single-axle or mid-axle trailer. Alternatively, the trailer sensor input 204B may include angle sensor data that detects and measures the angle between the trailer and tow vehicle, which may be used as input to the Trailer ECU 206 to ensure the trailer correctly follows the tow vehicle, again simulating standard single-axle or mid-axle trailer behavior. Additional inputs to ECU 206 may be velocity of the trailer via accelerometer and/or trailer wheel speed sensors.

For autonomous operation, when the trailer 100 is unhitched from the towing vehicle, the remote control input 204C can be utilized. This may allow an operator to manually maneuver the trailer 100 into the desired position using a handheld device such as a smartphone or a remote control. The remote control may resemble or be a game controller. The remote control input 204C provides input to the Trailer ECU 206, enabling the movement of the trailer. The connection to the ECU 206 may be established through a dedicated port for a physical connection—such as a game controller port or a USB port—or wirelessly for example via protocols like Bluetooth. This capability is particularly valuable for positioning the trailer accurately in tight spaces, whether at a campsite or in a residential storage space like a garage.

The wheel controllers, which include the rear right wheel controller 208A (controlling wheel 14A), the rear left wheel controller 208B (controlling wheel 14B), the front left wheel controller 208C (controlling wheel 14C), and the front right wheel controller 208D (controlling wheel 14D), carry out the commands from the Trailer ECU 206. Various implementations are possible: the front set of wheels may be configured to steer while the rear wheels remain passive, or the rear set may steer while the front wheels are passive, or both front and rear sets may be capable of steering. Optionally, one set of wheels may be configured to both steer and propel the trailer, or both sets may provide steering and propulsion capabilities. The wheel controllers 208A, 208B, 208C and 208D operate according to their specific implementation to provide the necessary steering and propulsion for the movement of the trailer 100.

The ECU 206 is responsible for processing the input sources and generating appropriate control signals for the wheel controllers 208A, 208B, 208C and 208D based on their individual capabilities. The Trailer ECU and the wheel controllers may receive power from a battery located on the trailer, ensuring that the system can operate independently of the tow vehicle power supply. The Trailer ECU 206 analyzes the input data and determines the necessary steering and/or propulsion commands to be sent to each wheel controller according to its specific function.

The ECU 206 may control the four-wheel trailer by receiving steering input data from one of the available input sources 204A, 204B, or 204C. The ECU 206 may determine which operational mode to engage based on the input source and vehicle status—if receiving data from the tow vehicle input 204A or trailer sensors 204B, it may select forward or reverse mode based on the direction; if the trailer is unhitched or the ECU 206 detects input from the remote control 204C without an active tow vehicle connection, it may engage remote control mode. The ECU 206 may then calculate the appropriate steering angles for the trailer wheels based on the selected mode and send actuation commands to the wheel controllers 208A-208D. This coordinated control may enable the four-wheel trailer to track and maneuver like a single-axle trailer, despite having wheels at all four corners. The remote control mode may allow precise positioning of the trailer in tight spaces or challenging terrain, whether hitched or unhitched.

The quad camper trailer 100 may include a battery. The battery may be located under the storage in the rear of the quad camper trailer 100. The battery may power the front or rear or both sets of wheels with an Electronic Control Unit (ECU) 206. The batteries may be charged some by the powered wheels 14A, 14B, 14C and 14D during braking with regenerative brakes that charges the camper batteries and improves camper braking performance decreasing load on the tow vehicle. The regenerative brakes may use the same propelling motors as electrical generators.

The quad camper trailer 100 may operate in multiple operational modes, with the electronic control unit 206 controlling the trailer behavior in each mode. These operational modes may include a forward mode, reverse mode, and remote control/crawl mode.

In forward mode: the front wheels may steer themselves and follow the tow vehicle as in typical flat vehicle towing setups without any active steering. The quad camper trailer 100 may actively steer 2 or 4 wheels while in forward mode for the trailer to better handle cornering and improve maneuvering of the entire vehicle and trailer system.

In reverse mode: a Trailer Electronic Control Unit, ECU, receives telemetry information about the tow vehicle either directly from the tow vehicle or independently from sensors on the trailer. The telemetry information may allow the trailer to determine the direction of travel of the tow vehicle and speed. The ECU may apply kinematic equations to calculate the required steering angles, actuating the front or rear (or both) steerable wheels on the trailer to simulate single-axle trailer behavior, making the four-wheel trailer track and maneuver like a conventional single-axle or middle wheel towable trailer. This addresses the problem when reversing that is normally experienced when flat towing of a normal 4-wheel vehicle. The telemetry system may plug in directly to the OBD system on the tow vehicle to obtain necessary information to perform the required steering computation. The trailer direction input source may obtain the required data solely from angle sensor data measuring the angle between the tow bar and tow vehicle bumper, for example with distance sensor or via a trailer mounted camera or cameras. The ECU may automatically detect whether the tow vehicle is in forward or reverse mode via wheel spin sensors on the wheels of the trailer or by sensing the state of the reverse light signal in the hitch electrical harness.

In remote control/crawl mode: The camper may be unhitched from the tow vehicle and be operated at low speeds as you would a remote-control car. The rear or front (or both) wheels can have low speed electric motors powered by the camper's battery and allow it to move on its own for shorter distances. This will allow the camper to be parked in locations where maneuvering a conventional trailer with a tow vehicle is difficult such as tight garages or constrained camping spots. Remote control mode may be used by a spotter or tow vehicle driver when the camper is hitched to the tow vehicle for obstacle clearance/rock crawling. For crawl mode, the trailer may have differential locks at the rear, or the ECU may control the wheels to act as if there is a differential lock. and the trailer may have similar capabilities on the front wheels. The remote-control mode may also be utilized by the towing vehicle driver to assist in reversing the trailer. The powered wheels 14A, 14B, 14C and 14D may allow remote control maneuvering, Remote control may be through a phone app. The powered wheels 14 may also provide assistance on demand to the vehicle, for example for obstacle clearance, uphill on/off road climbs, or in other situations where the extra power for quad-camper may assist.

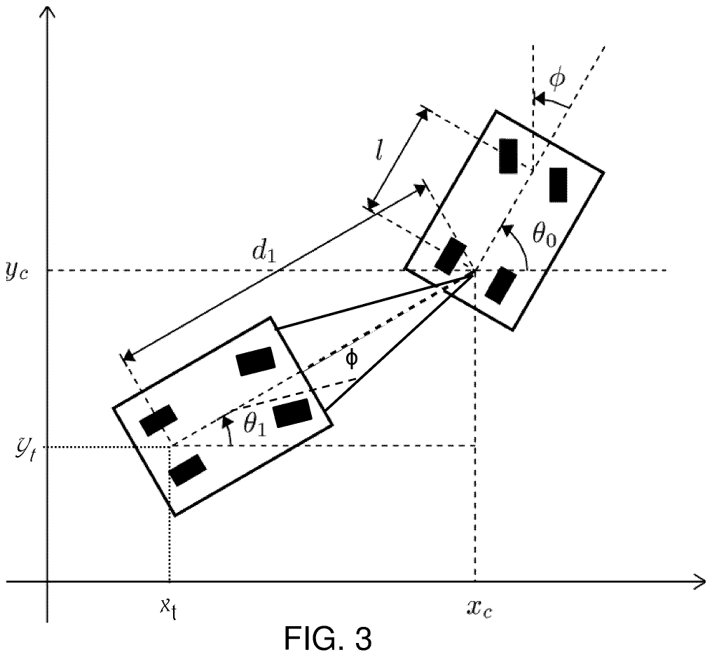

FIG. 3 illustrates a schematic top-view diagram of the kinematic relationship between a towing vehicle and the quad camper trailer 100 during operation. The towing vehicle (shown on the right) has an orientation angle θ₀ relative to the reference coordinate system, while the quad camper trailer (shown on the left) has an orientation angle θ₁. The articulation angle between the towing vehicle and trailer is the difference between these orientation angles (θ₀-θ₁). The distance d₁ represents the effective distance from the towing vehicle's rear axle (where the hitch is assumed to be located) to the center of the rear axle that would be single-axle position on the trailer. The quad camper's front wheels are steerable (as indicated by the angled wheel symbols), while the rear wheels remain fixed. This geometric configuration is used by the control algorithm, which calculates the required front wheel steering angle φₜ for the quad camper trailer based on the measured articulation angle φ to ensure the quad camper mimics the behavior of a conventional single-axle trailer during all maneuvering operations, particularly during reversing.

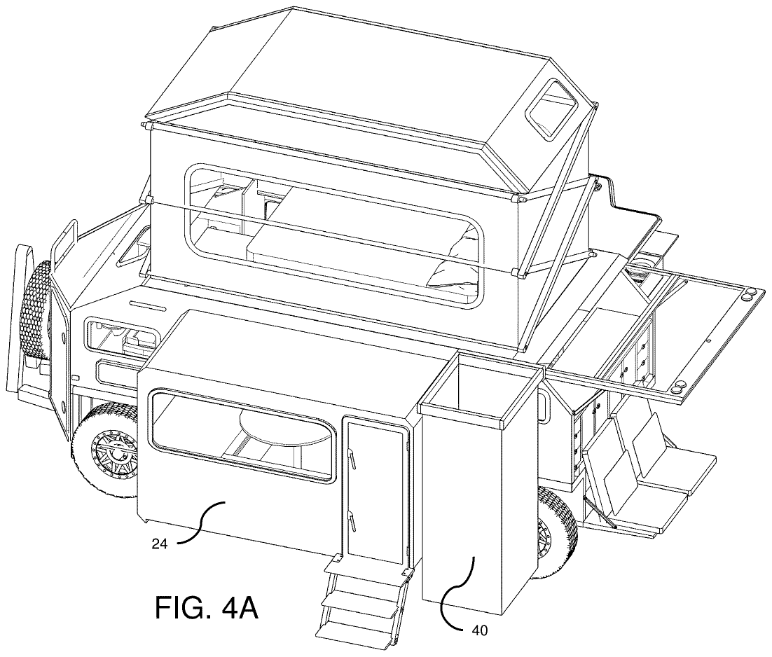

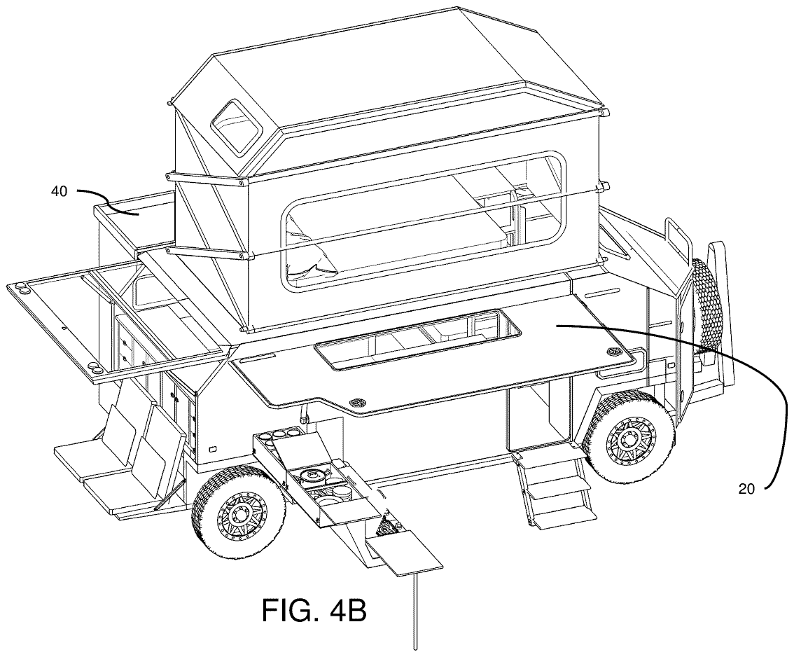

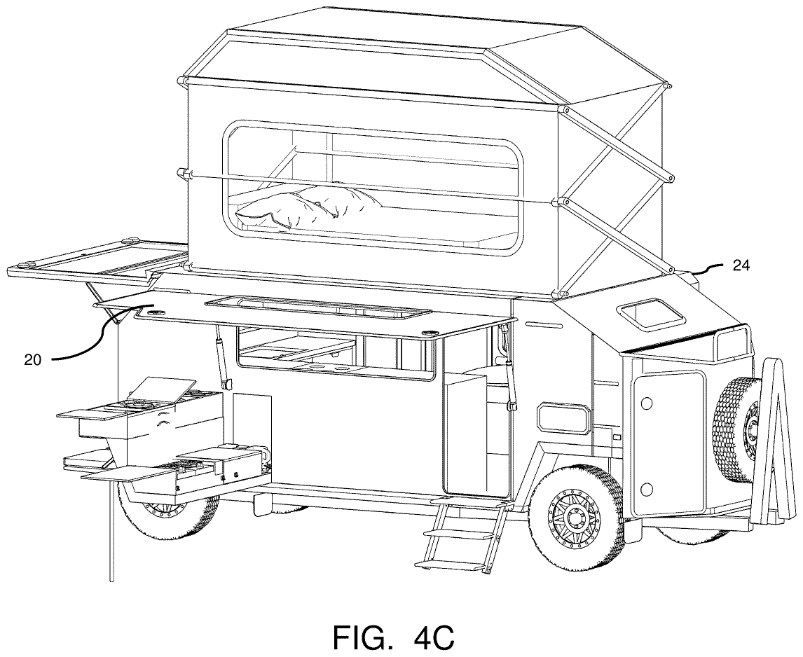

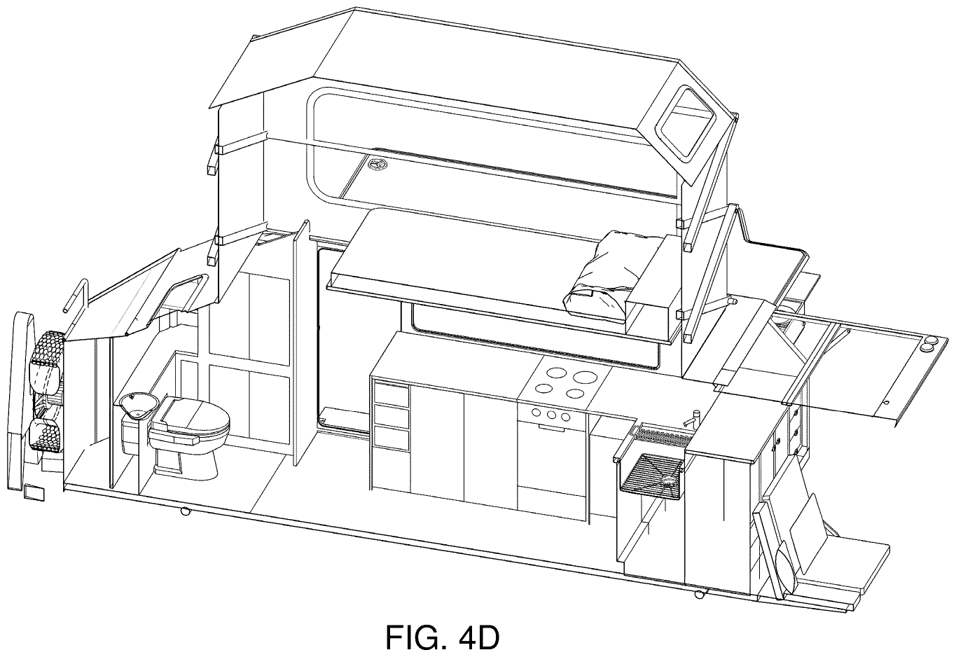

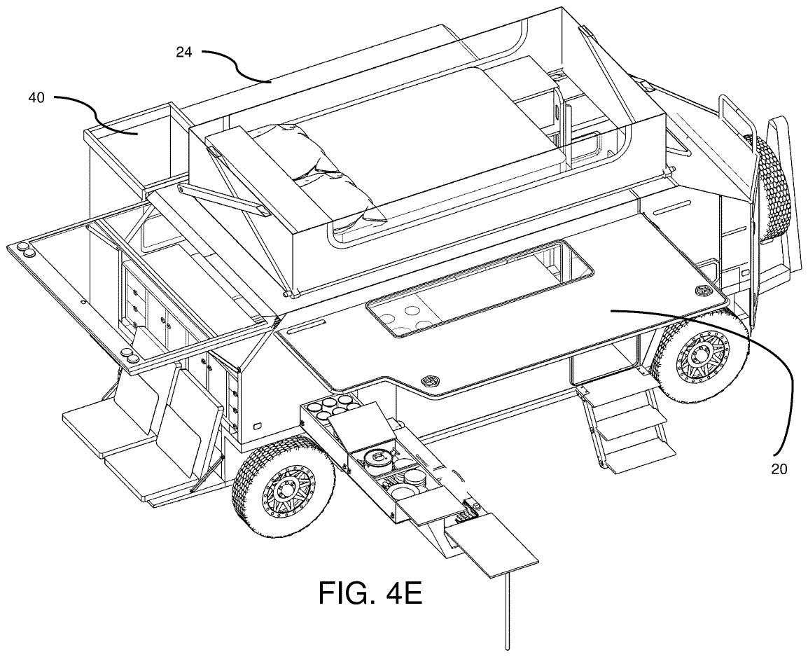

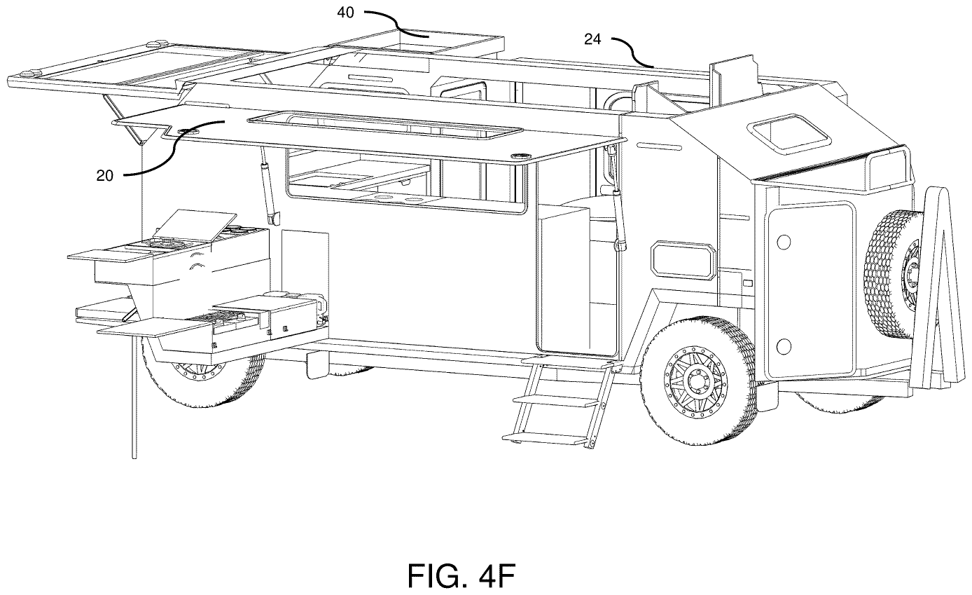

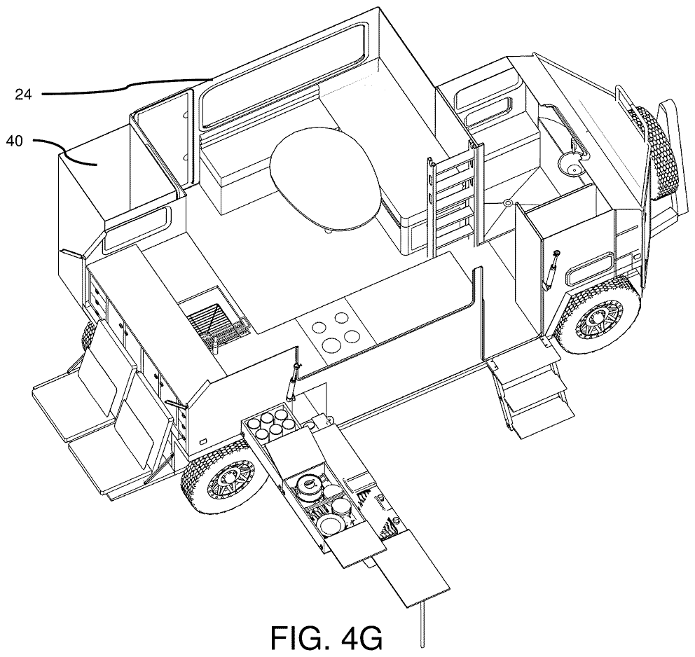

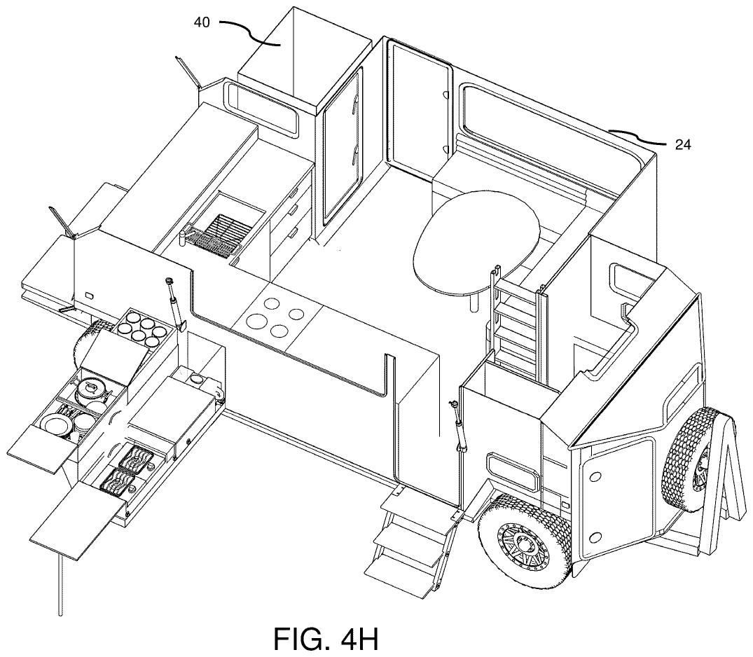

FIGS. 4A-4H show the quad camper trailer in fully deployed configuration. In the fully deployed configuration, the quad camper trailer 100 may have multiple expandable elements extended to maximize living and functional space. The hard side awning 20 may be in its open position, the slide-out refrigerator and grill may be deployed. The slide-out section 24 may be fully extended to create the larger living area. May include the upper floor pop-up tent deployed. A hard rear awning may also be deployed. The exterior shower 40 may be accessible with its fold-out tent privacy enclosure extended. The ECU 206 may coordinate the deployment sequence and may ensure that the trailer is properly leveled using the auto-level function before allowing full deployment of the slide-outs and other expandable elements.

The quad camper trailer 100 may have a hard side awning 20. The hard side awning 20 may be nearly as tall as the trailer. The hard side awning 20 may be electrically operated. When the hard side awning 20 is opened there may be a pass through indoor/outdoor kitchen with a slide-out refrigerator and grill. The hard awning 20 may be designed to withstand wind that may be encountered in a camping location. Typical camper awnings don't last in windy conditions as they are made of soft material. The hard awning 20 may have a window that matches the kitchen opening, so when the hard awning 20 is in the down position the hard awning 20 windows match the opening on the side wall.

The quad camper trailer 100 may have at least one slide-out section 24 that can create a larger living area. The larger living area may be larger because of the lower floor made possible by the lack of mid-camper axle and wheels. The slide-out 24 may be positioned on the side opposite the entry door/kitchen/awning/mud room. The slide-out section 24 may extend when the trailer is in the lowered camping mode, where the adjustable suspension system may have lowered the trailer to provide a ground-to-floor step height of less than 10 inches. When extended in this lowered camping mode, the slide-out floor height may be maintained within 3 inches of the main trailer floor height, providing a nearly level transition between the main living area and the slide-out section. This minimal height differential between the slide-out floor and the main trailer floor may eliminate the need for steps or significant transitions within the living space, thereby maximizing usable interior space and improving accessibility. The coordination between the suspension system's lowered camping mode and the slide-out deployment may ensure that the slide-out section can extend fully while maintaining proper ground clearance and structural stability. The electronic control unit may prevent slide-out extension when the trailer is in the raised travel mode to ensure safe operation.

A mud room may be attached to any of the entry doors. An outside shower 40 may be attached to any of the entry doors.

The quad camper trailer 100 may have a slide out removable toilet. The slide out removable toilet may be located in the front storage area.

The quad camper trailer 100 may have solar power cells as part of a solar power system for charging the batteries.

The quad camper trailer 100 may have a low-voltage air-conditioning system, and a heat pump offering both heating and cooling capabilities, or a direct current (DC) air conditioner.

The quad camper trailer 100 may have diesel powered room heat, hydronic floor heat, and water heat.

The quad camper trailer 100 may have an electric air compressor and an adjustable suspension system for automatic leveling of the camper on various surfaces and terrains. The adjustable suspension system may provide a raised travel mode for off-road ground clearance in rough/camping terrains and for clearing obstacles. The adjustable suspension system may also provide a lowered camping mode with ground-to-floor step height of less than 10 inches, which may provide a low center of mass for highway driving and may facilitate easy entry and exit from the trailer.

Unlike typical mid-axle trailers that are 12-24 inches off the ground and cannot accommodate large tires for off-roading, the quad camper trailer 100 may accommodate wheel sizes up to 35 inches in diameter while still achieving a low floor height when needed. The height off the ground may be typically half the wheel dimension plus whatever the height of the suspension is. With the adjustable suspension system and leveling capabilities, the trailer floor may be lowered to be less than 10 inches from the ground, or may be lowered to less than 7 inches from the ground, or may even be lowered to be 4 inches from the ground in optimal conditions. This low floor height in the lowered camping mode may eliminate the need for deployable stairs that are common on conventional trailers, as typical stairs are 4 to 7 inches high and most stairs in practice are at least a foot.

The suspension system may level the trailer when in the lowered camping mode, so when on uneven ground the user may enable ‘auto level,’ for example on the remote control, and the suspension system may automatically adjust to make the camper level. The ECU 206 may control both the adjustable suspension system and the remote control steering, managing the transition between the raised travel mode and the lowered camping mode. The ECU 206 may also control the auto leveling function when the trailer is in the lowered camping mode. The adjustable suspension may be air suspension, hydraulic, or other suspension type that allows for manipulating individual wheel suspension height via the ECU 206.

The quad camper trailer 100 may have a parking brake.

The quad camper trailer 100 may have power generation, for example a diesel generator. The power generator may be used for charging an EV tow vehicle.

With the mid-wheel axle removed there is approximately 7 ft interior height of the quad camper trailer 100 it is easy to mount a roof top bed and a slide with 2 doors, one to the outside and one to an fold-out tent privacy covered outdoor shower/toilet area. As such the quad camper trailer 100 has 3 exit doors when deployed with a usable 2 story configuration. Conventional trailers in this category do not have sufficient height (due to the constraint of fitting in garages while having a mid-axle) to avoid putting the bed in the main living area as opposed to above it.

In addition, the trailer/camper may contain conventional components such as pop tops, 360 awnings, external storage, spare tire, electrohydraulic brakes, fresh/grey/black water storage, external shower enclosure and system. In the preferred implementation all liquid storage tanks should be in the climate-controlled part of the camper (such as under the bed) allowing the heating system to always keep the camper above freezing.

Alternate implementations may employ different steering schemes such as in reverse mode the front camper wheels locking straight, and the rear wheels of the camper articulating according to telemetry.

To further enhance the system's efficiency and sustainability, the wheel controllers may incorporate regenerative braking capabilities. During braking or deceleration, the electric motors can be used as generators, converting the trailer's kinetic energy back into electrical energy, which is then stored in the battery. This regenerative braking feature helps to extend the battery's range and reduces the overall energy consumption of the system.

1. A trailer comprising:
a front set of wheels and a rear set of wheels, where at least one set of wheels is electronically steerable; and
an electronic control unit configured to receive steering input and control the at least one set of steerable wheels to simulate single-axle trailer behavior.

2. The trailer of claim 1, where the steering input comprises angle sensor data measuring the angle between the trailer and towing vehicle.

3. The trailer of claim 1, where the steering input is received via an OBD port connection.

4. The trailer of claim 1, where the electronic control unit operates in multiple operational modes including at least a forward mode and a reverse mode.

5. The trailer of claim 4, where the reverse mode actively steers wheels to simulate single-axle trailer behavior during backing up.

6. The trailer of claim 4, further comprising a remote control mode for unhitched operation.

7. The trailer of claim 4, where the electronic control unit automatically detects the operational mode based on at least one of reverse light signals or wheel rotation direction.

8. The trailer of claim 1, further comprising regenerative braking where wheel motors act as generators during braking to charge trailer batteries.

9. The trailer of claim 1, further comprising a hinged tow bar where the tongue weight consists essentially of the tow bar weight.

10. The trailer of claim 9, where the hinged tow bar is rotatable to a vertical storage position.

11. The trailer of claim 1, further comprising an adjustable suspension system that:
provides a raised travel mode for off-road ground clearance; and
provides a lowered camping mode with ground-to-floor step height of less than 10 inches.

12. The trailer of claim 11, where the suspension system can level the trailer when in the lowered camping mode.

13. The trailer of claim 11, where at least one slide-out section extends in the lowered camping mode with a slide-out floor height within 3 inches of the main trailer floor height.

14. The trailer of claim 1, where the trailer accommodates wheel sizes up to 35 inches in diameter.

15. A method of controlling a four-wheel trailer comprising:
receiving steering input data from a towing vehicle;
determining an operational mode based on towing vehicle direction;
calculating steering angles for at least one set of trailer wheels based on the operational mode; and
actuating trailer wheel steering.

16. The method of claim 15, where actuating trailer wheel steering causes the four-wheel trailer to track like a single-axle trailer.

17. The method of claim 15, where calculating steering angles in reverse mode comprises applying kinematic equations to simulate single-axle behavior.

18. The method of claim 15, further comprising operating in a remote control mode for positioning the trailer.

19. A trailer comprising:
four wheels positioned at corners of the trailer with a front set and a rear set; and
an adjustable suspension system that provides a raised travel mode for off-road ground clearance and a lowered camping mode with ground-to-floor step height of less than 10 inches.

20. The trailer of claim 19, where:
at least one set of wheels is remote control steerable;
an electronic control unit controls both the adjustable suspension system and the remote control steering; and
the suspension system can level the trailer when in the lowered camping mode.
